(19) United States
(12) Patent Application Publication
(10) Pub. No.: US 2026/0323174 A1
(43) Pub. Date: Oct. 15, 2026

(54) MASK, IMAGE CAPTURING DEVICE, IMAGE CAPTURING SYSTEM, AND DATA GENERATION METHOD

(71) Applicant: Sony Semiconductor Solutions Corporation, Atsugi-shi, Kanagawa (JP)

(72) Inventor: Ryosuke UEMURA, Kanagawa (JP)

(73) Assignee: Sony Semiconductor Solutions Corporation, Atsugi-shi, Kanagawa (JP)

(21) Appl. No.: 19/473,804

(22) PCT Filed: Apr. 15, 2024
(86) PCT No.: PCT/JP2024/014965

§ 371 Date: Oct. 9, 2025

(30) Foreign Application Priority Data
Apr. 21, 2023 (JP) 2023-070363

(51) Int. Cl. H04N 23/955; G02B 5/00; G02B 26/06

(52) U.S. Cl. CPC H04N 23/955; G02B 5/003; G02B 26/06

(57) ABSTRACT

A mask includes a two-dimensional pattern including an optical amplitude modulation region or a phase modulation region having a symmetrical component that is symmetrical in a rotation direction about a preset rotation reference point, wherein the mask guides, based on the two-dimensional pattern, incident light to an image sensor. Additionally, the rotation reference point is set inside a pattern forming region where the two-dimensional pattern is provided.

### TECHNICAL FIELD

The present disclosure relates to a mask, an image capturing device, an image capturing system, and a data generation method.

### BACKGROUND ART

There is a lensless image sensor equipped with an optical modulator on which a known two-dimensional pattern is formed including an optical amplitude modulation region or a phase modulation region in the front stage of an image capturing element in the optical axis direction (hereinafter described to as a “mask”). (For example, see PTL 1).

The rangeless image sensor generates a decoded image of a subject by projecting light encoded by the effect of the characteristic two-dimensional pattern of the mask onto the image capturing element and decoding the mask effect by inverse calculation.

### CITATION LIST

### Patent Literature

PTL 1: International Publication No. 2019/176349

### SUMMARY OF INVENTION

### Technical Problem

However, with a general lensless image sensor, if the relative positional relationship between the mask and the image capturing element deviates from the predetermined relative position, the image quality of the decoded image may deteriorate.

Therefore, the present disclosure proposes a mask, an image capturing device, an image capturing system, and a data generation method capable of suppressing deterioration in the image quality of the decoded image.

### Solution to Problem

The mask according to an exemplary embodiment includes a two-dimensional pattern including an optical amplitude modulation region or a phase modulation region having a symmetrical component that is symmetrical in a rotation direction about a preset rotation reference point, wherein the mask guides, based on the two-dimensional pattern, incident light to an image sensor.

### BRIEF DESCRIPTION OF DRAWINGS

FIG. 1 is an explanatory diagram illustrating an overview of the configuration and operation of an image sensor according to embodiments.

FIG. 2 is an explanatory diagram illustrating an example of occurrence of a rotation error according to a first embodiment.

FIG. 3 is a graph illustrating SSIM of a decoded image illustrated in FIG. 2.

FIG. 4A is an explanatory diagram illustrating a mask generation procedure according to the first embodiment.

FIG. 4B is an explanatory diagram illustrating one example of a phase modulation mask according to the first embodiment.

FIG. 5 is an explanatory diagram illustrating an image employing a robust mask according to the first embodiment.

FIG. 6 is a graph illustrating the SSIM of the decoded image illustrated in FIG. 5.

FIG. 7 A is an explanatory diagram of a symmetrical component in the robust mask according to the first embodiment.

FIG. 7B is an explanatory diagram of the symmetrical component in the robust mask according to the first embodiment.

FIG. 7C is an explanatory diagram of the symmetrical component in the robust mask according to the first embodiment.

FIG. 8 is an explanatory diagram of a rotation reference point according to the first embodiment.

FIG. 9 is an explanatory diagram illustrating images employing the robust mask with the shifted rotation reference point according to the first embodiment.

FIG. 10 is a graph illustrating the SSIM of the decoded image illustrated in FIG. 9.

FIG. 11 is an explanatory diagram illustrating an example of occurrence of a crop error according to a second embodiment.

FIG. 12 is an explanatory diagram illustrating an example of occurrence of the crop error according to the second embodiment.

FIG. 13 is an explanatory diagram illustrating an example of occurrence of the crop error according to the second embodiment.

FIG. 14 is a graph illustrating the SSIM of the decoded image illustrated in FIG. 13.

FIG. 15 is an explanatory diagram of a robust mask according to the second embodiment.

FIG. 16 is an explanatory diagram of effects of the robust mask according to the second embodiment.

FIG. 17 is an explanatory diagram illustrating an example of a pattern of the robust mask according to the second embodiment.

FIG. 18 is an explanatory diagram illustrating an example of a pattern of the robust mask according to the second embodiment.

FIG. 19 is an explanatory diagram illustrating an example of a pattern of the robust mask according to the second embodiment.

FIG. 20 is an explanatory diagram illustrating an example of a pattern of the robust mask according to the second embodiment.

FIG. 21 is an explanatory diagram illustrating a modification of the image sensor.

FIG. 22 is an explanatory diagram illustrating a modification of the image sensor.

FIG. 23 is an explanatory diagram illustrating a modification of the image sensor.

FIG. 24 is an explanatory diagram illustrating a modification of the image sensor.

### DESCRIPTION OF EMBODIMENTS

Embodiments of the present disclosure will be described in detail below with reference to the drawings. Note that in each of the following embodiments, identical elements are denoted with identical reference signs to omit redundant descriptions.

### 1. Configuration of Image Sensor

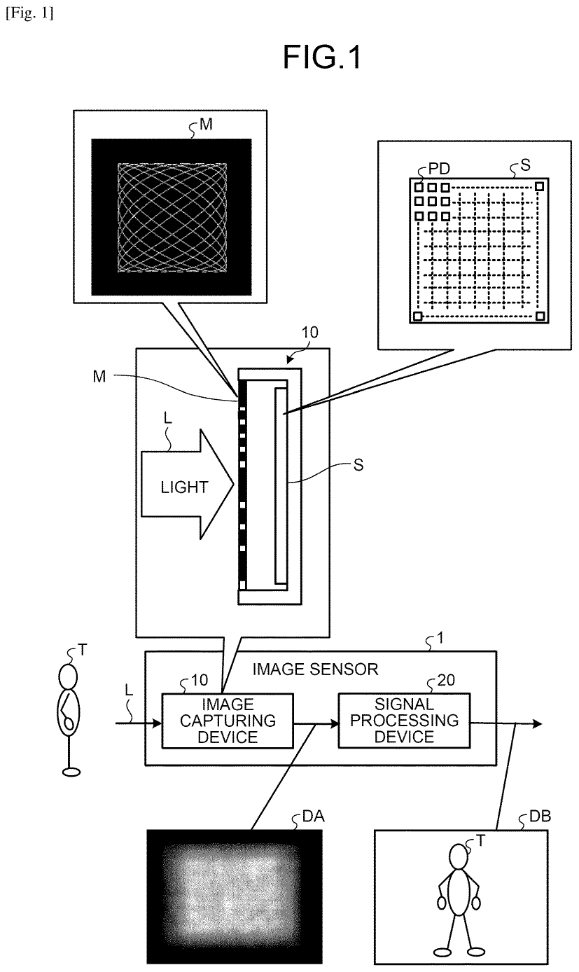

FIG. 1 is an explanatory diagram illustrating an overview of the configuration and operation of an image sensor 1 according to the embodiments. The image sensor 1 illustrated in FIG. 1 is a so-called lensless camera that does not need a lens to condense light emitted from each point of a subject onto each corresponding point on a sensor for image capturing.

As illustrated in FIG. 1, the image sensor 1 includes an image capturing device 10 and a signal processing device 20. The image capturing device 10 includes a mask M and an image capturing element S. The mask M is provided at the front stage of the image capturing element S in the optical axis direction. A known two-dimensional pattern including an optical amplitude modulation region or a phase modulation region is formed on the mask M.

The optical amplitude modulation is implemented using light-blocking members or members with varying degrees of transmittance. The optical phase modulation is implemented by controlling the uneven structure within the mask plane, and by controlling the refractive index distribution of the mask and the effective refractive index obtained by controlling the density of members with a plurality of refractive indices at size orders smaller than the wavelength, and the like. The example illustrated in FIG. 1 is an example of amplitude modulation.

When capturing an image of a subject T, the mask M modulates light L that is incident from the direction of the subject, with a known two-dimensional phase amplitude pattern, and then guides the light to the subsequent image capturing element placed at a certain distance away. As a result, a light intensity distribution corresponding to the shape of the subject T and the shape of the two-dimensional pattern of the mask M is projected onto a light-receiving surface of the image capturing element S.

The image capturing element S has a plurality of photo detectors PD arranged in a two-dimensional matrix on the light-receiving surface. By photoelectrically converting the light L received by each photo detector PD, the image capturing element S generates an encoded image DA in which the image of the subject T is encoded by the two-dimensional pattern of the mask M, and outputs the encoded image to the signal processing device 20. The encoded image DA, which is an image obtained by photoelectrically converting the light L incident via the mask M, is an image in which the subject T cannot be recognized with the naked eyes.

The image capturing principle of an encoded image DB by the image capturing element S is expressed by the following Formula (1).

Y=F×X+N (1)
Here,
Y: Light-receiving signal of each photo detector PD (one-dimensional data)
X: Scene vector (value of light L incident on the mask M during image capturing (one-dimensional data))
N: Noise
F: Imaging matrix (matrix defined by the two-dimensional pattern of the mask M and the distance between the mask and the image capturing element)
As can be seen from Formula (1), the light-receiving signal Y of each photo detector PD is a signal obtained by adding the noise N to light obtained by modulating the scene vector X during image capturing by the imaging matrix F.

The signal processing device 20 executes predetermined decoding processing on the encoded image DA, thereby generating a two-dimensional image that allows the subject T to be recognized in a similar manner to a general camera (hereinafter described as “decoded image DB”). For example, the signal processing device 20 multiplies the light-receiving signal Y of each photo detector PD described above by an inverse matrix F-1 of the imaging matrix F to restore the scene vector X, thereby generating and outputting the decoded image DB.

Considering that the number of pixels of a general image capturing element is on the order of several million pixels, Y will also have a vector size of similar order. If the scene vector X captured by the image capturing element also has a similar size, the imaging matrix F will be a huge matrix. Therefore, in complex signal processing, the memory and calculation amount become generally issues.

Various methods have been proposed to avoid this, and one of the most basic ideas is to assume (approximate) shift invariance in the point spread function.

As a physical explanation, the point spread function is the intensity distribution when light from a single point on the subject passes through the mask and reaches an image capturing surface. The assumption of shift invariance is similar to, even if the light originates from different single points on the subject, the above-described intensity distribution shifting without altering the intensity distribution itself.

As an explanation in the correspondence with Formula (1), the point spread function means each row of the imaging matrix F, and the assumption of shift invariance means that when comparing each row of the imaging matrix F, only the shift is occurring.

By assuming shift invariance, Formula (1) can be transformed as shown below, and the memory and calculation amount can be significantly compressed.

Y′=F′*X′+N′ (2)
Y′: Light-receiving signal of each photo detector PD (two-dimensional data)
X′: Scene matrix (value of light L incident on the mask M during image capturing (two-dimensional data))
N′: Noise
F′: Imaging matrix=point spread function
*: Convolution operation

In Formula (2), the imaging matrix F′ has the similar matrix size to Y′, and the huge memory is not required. Furthermore, the convolution operation can be processed at high speed due to the fast Fourier transform (FFT) algorithm.

By executing a deconvolution operation on Y′ with the imaging matrix F′, it is possible to restore the scene matrix X′. In deconvolution, to improve noise resistance, Wiener filter processing may be executed, and a normalization term that incorporates various known assumptions regarding scenes and the like may be added.

The assumption of shift invariance and the decoding signal processing based on the FFT deconvolution operation are particularly closely related to the second embodiment.

At this time, the relative positional relationship between the mask M and the image capturing element S may deviate from the predetermined relative position. For example, when the mask M is placed in a rotated state from the predetermined known position with respect to the image capturing element S, an error occurs in the relative positional relationship between the mask M and the image capturing element S (hereinafter referred to as “rotation error”). As the relationship in terms of size between the mask M and the image capturing element S and the incident angle of the light L increase, an error may occur in which not all of the desired light L is incident on the image capturing element S (hereinafter referred to as a “crop error”).

In this way, in the image capturing device 10, an error may occur due to disturbance, such as the relative positional relationship between the mask M and the image capturing element S, the size relationship between the mask M and the image capturing element S, and increase in the incident angle of the light L. In this case, the light-receiving signal Y of each photo detector PD in the encoded image DA becomes a signal modulated by a matrix different from the known imaging matrix F defined by the two-dimensional pattern of the mask M.

Therefore, even if the inverse matrix F-1 of the known imaging matrix F is applied to the light-receiving signal Y modulated by a matrix different from the known imaging matrix F, the signal processing device 20 cannot restore the correct scene vector X. As a result, the decoded image fails and becomes a state in which the subject T cannot be recognized.

Therefore, the image capturing device 10 according to the present embodiment is configured to suppress deterioration in the image quality of the decoded image by providing the mask M with characteristics according to the type of disturbance such as the rotation error and the crop error.

For example, for the rotation error, by providing the mask M with slight rotational symmetry in advance, the robustness can be improved at each stage. For the crop error, by providing the mask M with translational symmetry in advance, the robustness can be improved at each stage with light decoding processing.

This allows the image capturing device 10 to improve various types of robustness at each stage while maintaining the degree of freedom in the modulation pattern that affects the ease of decoding (ease of solving inverse problems). Furthermore, since the characteristics of rotational symmetry and translational symmetry provided in the mask M can be combined, it is possible to simultaneously improve robustness against various error factors, leading to significant reductions in manufacturing costs and mitigation of changes over time.

A first embodiment that solves problems caused by the rotation error and a second embodiment that solves problems caused by the crop error will be described below.

### 2. First Embodiment

### 2-1. Example of Occurrence of Rotation Error

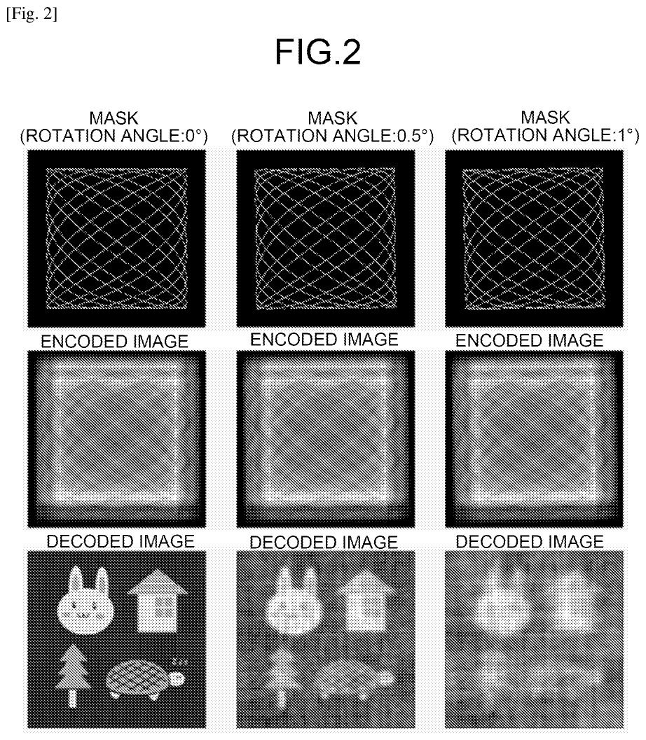

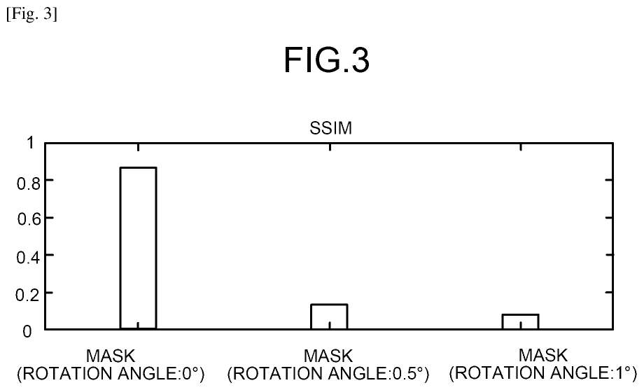

Here, cases where the rotation angles of the mask M with respect to the image capturing element S are 0°, 0.5°, and 1° will be described. FIG. 2 is an explanatory diagram illustrating an example of occurrence of the rotation error according to the first embodiment. The rotation angle illustrated in FIG. 2 is a rotation angle of the mask when the center of gravity of the two-dimensional pattern on the mask M is set as a rotation reference point. FIG. 3 is a graph illustrating structural similarity index measure (SSIM) of the decoded image illustrated in FIG. 2. The SSIM indicates that the closer the value is to 1, the better the image quality. The evaluation index may be other than the SSIM.

As illustrated in FIGS. 2 and 3, when the rotation angle of the mask M is 0°, that is, when the mask M is placed at the correct known position without any rotation error, the signal processing device 20 can generate the clear decoded image DB. In contrast, as the rotation angle of the mask M gradually increases to 0.5° and 1°, the image quality of the decoded image DB gradually deteriorates.

### 2-2. Mask Generation Procedure According to Embodiment

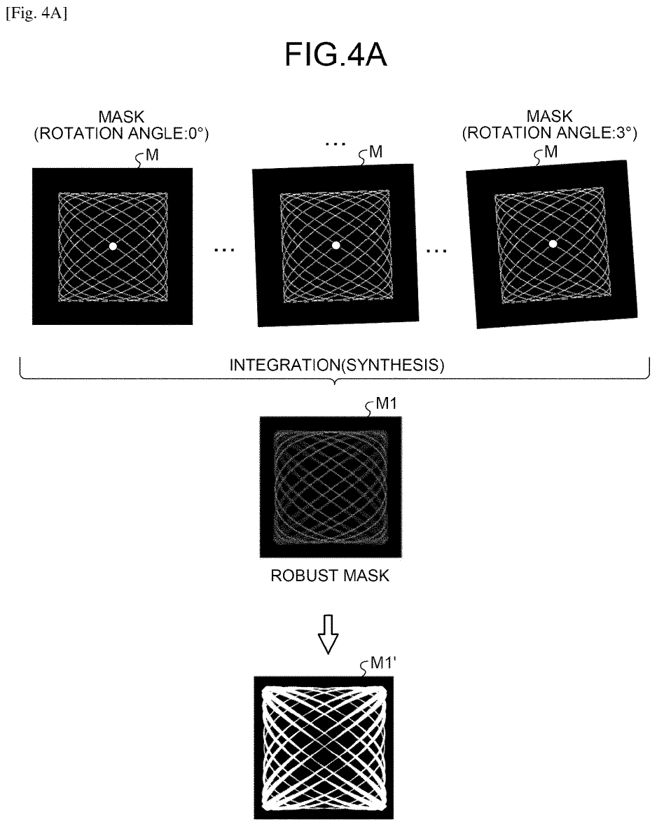

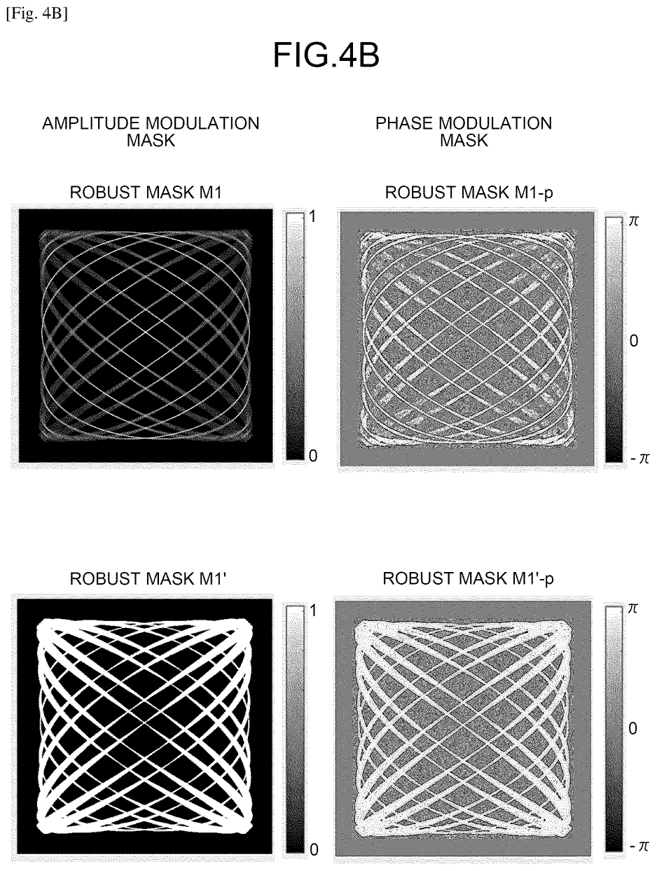

FIG. 4A is an explanatory diagram illustrating a mask generation procedure according to the first embodiment. FIG. 4B is an explanatory diagram illustrating one example of a phase modulation mask according to the first embodiment. Here, the case of optical amplitude modulation will be described as an example. As illustrated in FIG. 4A, when generating the mask according to the first embodiment (hereinafter described as “robust mask M1”), image data of each mask M is acquired while sequentially rotating the mask M by a predetermined rotation angle.

At this time, for example, the mask M is rotated using the center of gravity of the two-dimensional pattern of the mask M as the rotation reference point. The example illustrated in FIG. 4A illustrates a case where the mask M is rotated from 0° to 3°. Then, by integrating (synthesizing) the image data of each mask M, the two-dimensional pattern of the robust mask M1 is acquired.

At this time, the integration (synthesis) range of image data may change depending on the distance from the center. The integrated (synthesized) value of the image data may be binarized using a certain threshold to create a new robust mask M1′ of two-dimensional pattern.

As a result, in the two-dimensional pattern of the robust mask M1, for example, like a star image captured by aligning the camera's optical axis with the polar star and taking a long exposure, as the distance from the rotation reference point increases, the length of an arc-shaped pattern of a symmetrical component that is symmetrical in the rotation direction about the rotation reference point increases.

Then, after acquiring the two-dimensional pattern by the procedure described above, for example, the robust mask M1 is completed by forming the acquired two-dimensional pattern of the robust mask M1 on a transparent substrate such as a glass plate by a known method.

As a result, the two-dimensional pattern of the robust mask M1 becomes a two-dimensional pattern including the optical amplitude modulation region having a symmetrical component that is symmetrical in the rotation direction about the preset rotation reference point.

When the mask executes the optical phase modulation, the procedure to obtain the phase distribution on the mask surface by using algorithm such as the iterative Fourier phase recovery method may be added, by using the robust mask M1 created according to the above procedure as the target intensity pattern value on the image capturing surface, and considering the distance between the mask and the image capturing surface. FIG. 4B illustrates an example in which phase modulation masks M1-p and M1′-p are created based on the robust masks M1 and M1′, respectively.

Then, after acquiring the new two-dimensional pattern by using the procedure described above, for example, the robust mask is completed by forming the new two-dimensional pattern on a transparent substrate such as a glass plate by using a known method.

As a result, the two-dimensional pattern of the robust mask becomes a two-dimensional pattern including the optical phase modulation region having a symmetrical component that is symmetrical in the rotation direction about the preset rotation reference point. When the mask executes the optical phase amplitude modulation as well, the robust mask can be created by using the similar method to the case of executing the optical phase modulation.

### 2-3. Evaluation of Decoded Image Employing Robust Mask

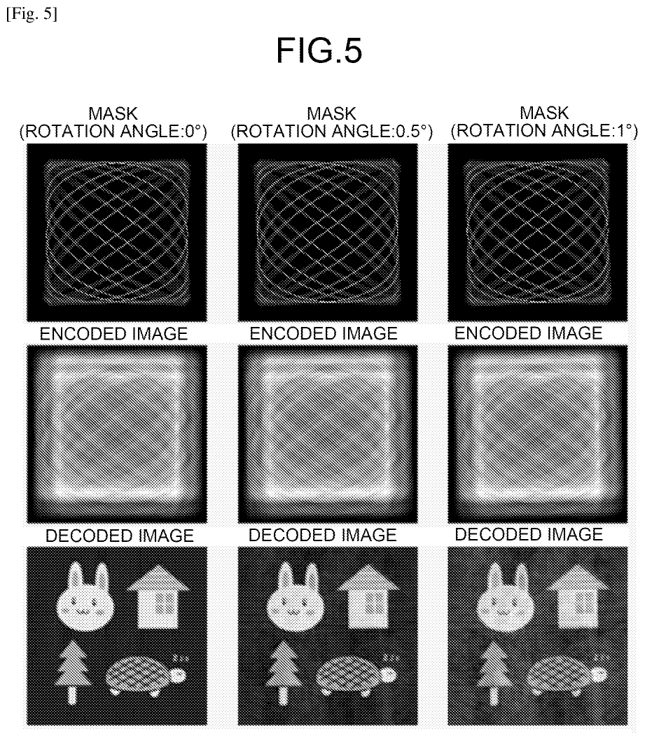

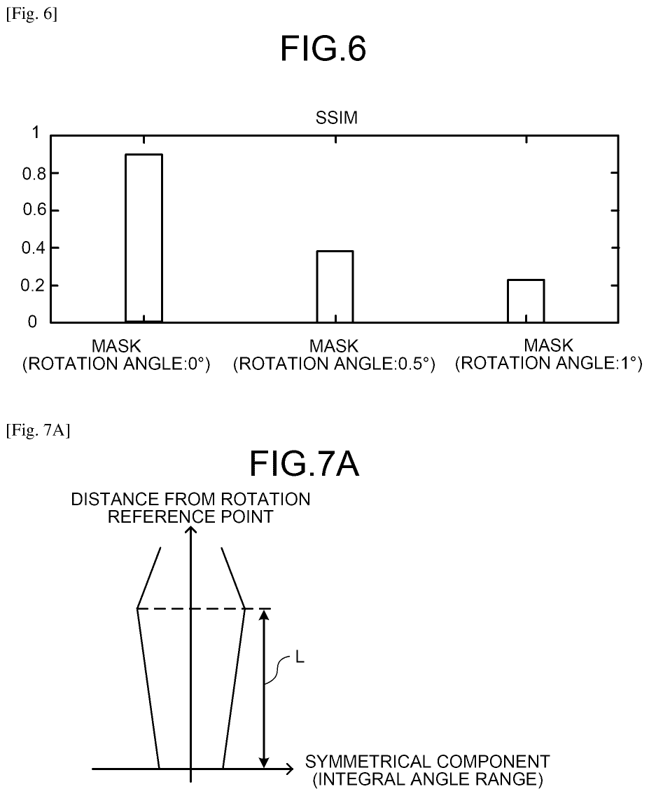

Here, the case where the robust mask M1 is employed and the image of the subject is captured by rotating the robust mask M1 by 0°, 0.5°, and 1° will be described. FIG. 5 is an explanatory diagram illustrating the image employing the robust mask M1 according to the first embodiment. The rotation angle illustrated in FIG. 5 is a rotation angle of the mask when the center of gravity of the two-dimensional pattern on the robust mask M1 is set as the rotation reference point. FIG. 6 is a graph illustrating the SSIM of the decoded image illustrated in FIG. 5.

As illustrated in FIG. 5, when the robust mask M1 is employed, in the decoded image DB, the image quality deteriorates slightly as the rotation angle of the robust mask M1 increases, but the image quality that is high enough to recognize the subject is secured.

As illustrated in FIG. 6, in all cases where the rotation angle of the robust mask M1 is 0°, 0.5°, and 1°, the SSIM of the decoded image DB has a value higher than the SSIM of the decoded image DB when the mask M illustrated in FIG. 3 is employed. This also shows that by employing the robust mask M1, it is possible to suppress the deterioration in the image quality of the decoded image DB.

### 2-4. Symmetrical Component in Two-Dimensional Pattern of Robust Mask

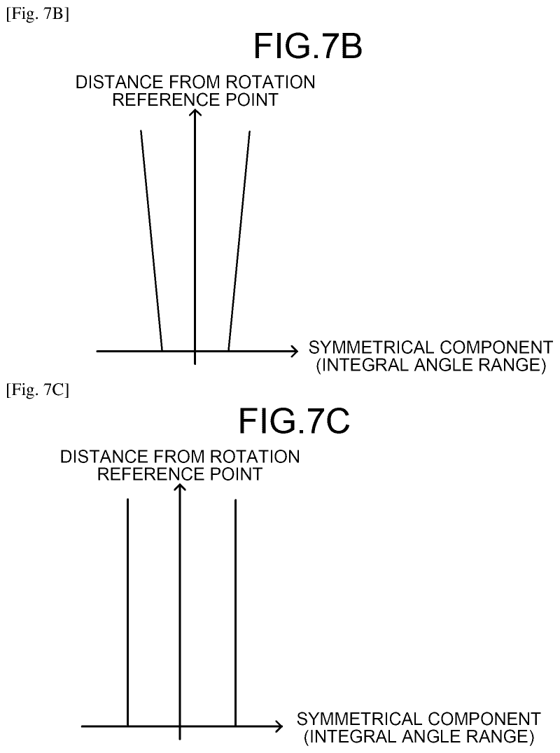

FIGS. 7A, 7B, and 7C are explanatory diagrams of symmetrical components in the two-dimensional pattern of the robust mask M1 according to the first embodiment. The vertical axis of the graphs illustrated in FIGS. 7A, 7B, and 7C is the distance from the rotation reference point of the robust mask M1 to the symmetrical component. The horizontal axis is the integral angle range of the symmetrical component.

As illustrated in FIG. 7A, the symmetrical component that is symmetrical in the rotation direction about the rotation reference point may have at least a portion in which the integral angle range increases as the distance from the rotation reference point increases. In this case, the symmetrical component has a portion where the arc length of an arc-shaped pattern becomes long from the rotation reference point toward the periphery of the pattern forming region where the two-dimensional pattern is provided.

As illustrated in FIG. 7B, the symmetrical component that is symmetrical in the rotation direction about the rotation reference point may be configured such that the integral angle range increases as the distance from the rotation reference point increases. In this case, in the symmetrical component, the arc length of the arc-shaped pattern increases from the rotation reference point toward the periphery of the pattern forming region where the two-dimensional pattern is provided.

As illustrated in FIG. 7C, the symmetrical component that is symmetrical in the rotation direction about the rotation reference point may be configured to have a constant integral angle range regardless of the distance from the rotation reference point. In this case, in the symmetrical component, the arc length of the arc-shaped pattern increases in proportion to the distance from the rotation reference point.

From the viewpoint of the degree of freedom of the two-dimensional pattern, the example illustrated in FIG. 7A has the highest degree of freedom, and the example illustrated in FIG. 7C has the lowest degree of freedom. From the viewpoint of robustness against the rotation error, the example illustrated in FIG. 7C has the highest robustness, and the example illustrated in FIG. 7A has the lowest robustness.

Here, regarding the integral range, the explanatory diagram of the first embodiment presents three degrees as one example, but there is no restriction on the upper and lower limits. It is possible to design on a case-by-case basis depending on the manufacturing capacity regarding mask alignment, the desired image quality for each use case, and the required degree of freedom of the two-dimensional pattern.

### 2-5. Rotation Reference Point

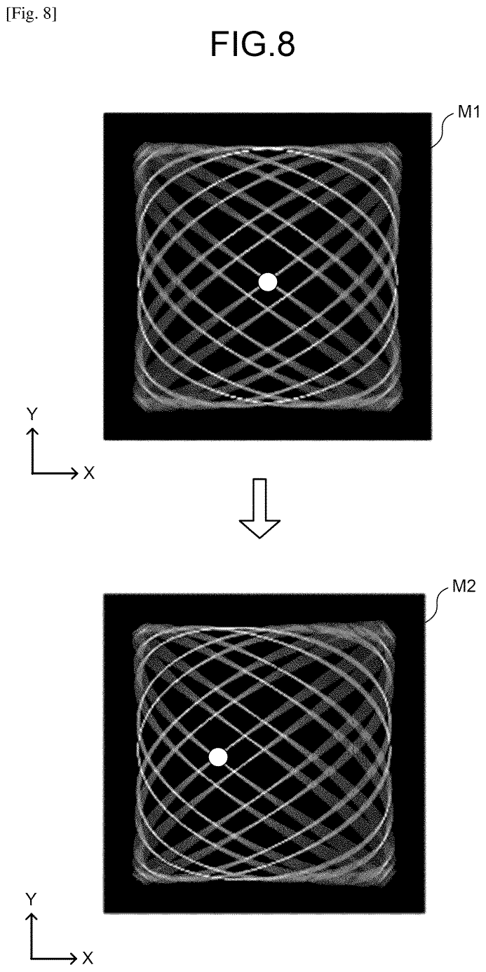

FIG. 8 is an explanatory diagram of the rotation reference point according to the first embodiment. FIG. 8 illustrates an X-Y orthogonal coordinate system for convenience. So far, the case has been described in which the rotation reference point for rotating the mask M to acquire the robust mask M1 is set at the center of gravity of the pattern forming region where the two-dimensional pattern is formed, as illustrated in the upper figure of FIG. 8, but this is one example.

The position of the rotation reference point may be set, for example, at a position shifted from the center of gravity of the pattern forming region, as illustrated in the lower figure of FIG. 8. The lower figure of FIG. 8 illustrates a robust mask M2 when the rotation reference point is set to be shifted by 20% from the center of gravity of the pattern forming region in the negative direction of the X-axis. If the rotation reference point is shifted 100% from the center of gravity of the pattern forming region, the rotation reference point will be set at the periphery of the pattern forming region.

Note that the rotation reference point may be set at an arbitrary position within the mask M, but is preferably set inside the pattern forming region from the viewpoint of robustness against the rotation error, and is more preferably provided at a position shifted within 50% from the center of gravity of the pattern forming region.

That is, the rotation reference point is more preferably set at a position where the distance from the center of gravity of the pattern forming region is equal to or less than half the distance from the center of gravity of the pattern forming region to the periphery of the pattern forming region. In this case, the best position for setting the rotation reference point is the center of gravity of the pattern forming region.

By making it possible to arbitrarily set the position of the rotation reference point, the degree of freedom in the pattern is improved. Meanwhile, if the rotation reference point is set at the center of gravity of the pattern forming region, the robustness against the rotation error will be improved, but the manufacturing process will be more delicate.

2-6. Evaluation of Decoded Image Employing Robust Mask with Shifted Rotation Reference Point

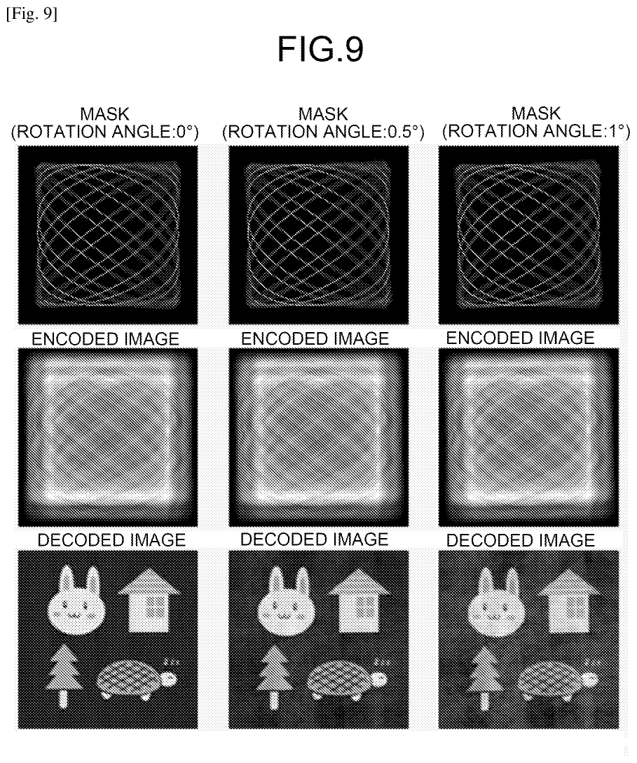

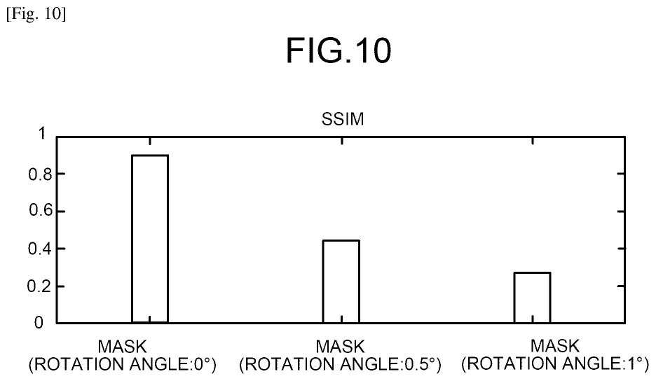

Here, the case where the robust mask M2 illustrated in the lower figure of FIG. 8 is employed and the image of the subject is captured by rotating the robust mask M2 by 0°, 0.5°, and 1° will be described. FIG. 9 is an explanatory diagram illustrating images employing the robust mask M2 with the shifted rotation reference point according to the first embodiment. The rotation angle illustrated in FIG. 9 is a rotation angle of the mask when the center of gravity of the two-dimensional pattern on the robust mask M2 is set as the rotation reference point. FIG. 10 is a graph illustrating the SSIM of the decoded image illustrated in FIG. 9.

As illustrated in FIG. 9, when the robust mask M2 is employed, in the decoded image DB, the image quality deteriorates slightly as the rotation angle of the robust mask M2 increases, but the image quality that is high enough to recognize the subject is secured.

As illustrated in FIG. 10, in all cases where the rotation angle of the robust mask M2 is 0°, 0.5°, and 1°, the SSIM of the decoded image DB has a value higher than the SSIM of the decoded image DB when the mask M illustrated in FIG. 3 is employed. This also shows that by employing the robust mask M2, it is possible to suppress the deterioration in the image quality of the decoded image DB.

### 3. Second Embodiment

3-1. Example of occurrence of Crop Error

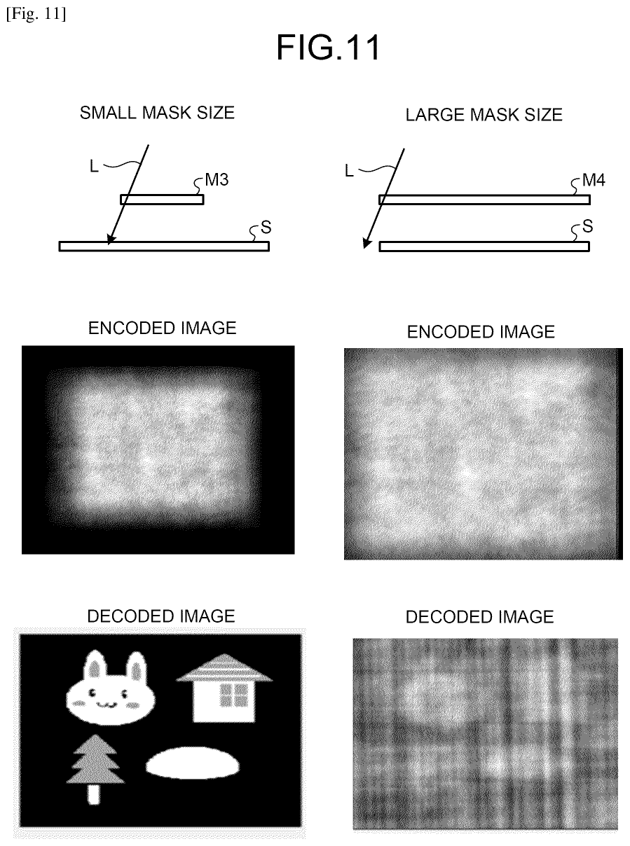

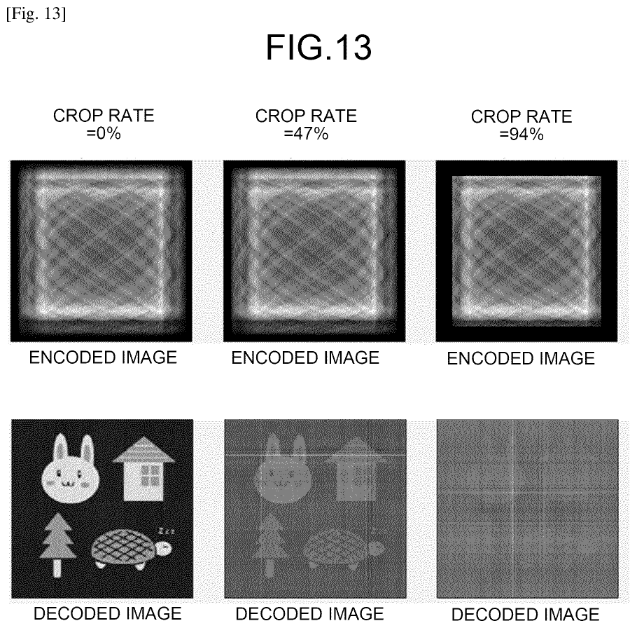

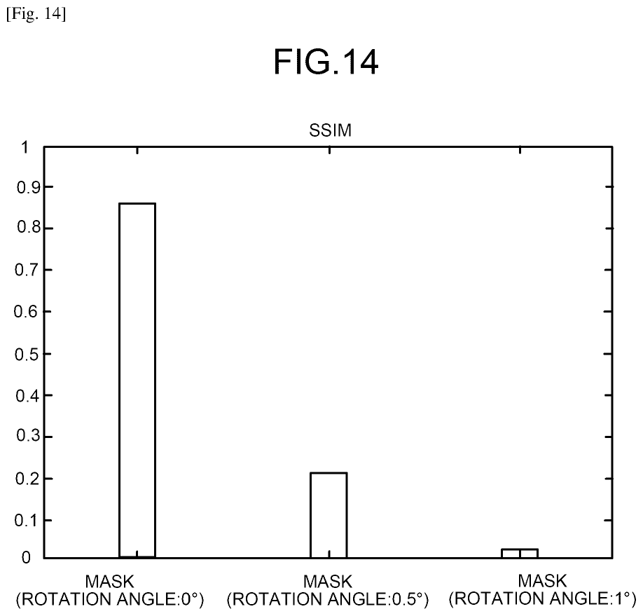

FIGS. 11 to 13 are explanatory diagrams illustrating an example of occurrence of the crop error according to the second embodiment. The crop rate illustrated in FIG. 13 is an index indicating what percentage of light arriving from an assumed angle of view falls outside the image capturing element S in the direction in which cropping is most likely to occur. Note that the assumed angle of view here is the incident angle of light defined by the incident characteristics of the image capturing element S. FIG. 14 is a graph illustrating the SSIM of the decoded image illustrated in FIG. 13.

As described above, in complex signal processing, to avoid problems with the memory and calculation amount, there is an idea of assuming (approximating) shift invariance in the point spread function. In Formula (2), by executing a deconvolution operation on Y′ with the imaging matrix F′, it is possible to restore the scene matrix X′. The deconvolution operation can be processed at high speed by using the fast Fourier transform (FFT) algorithm.

In deconvolution, to improve noise resistance, Wiener filter processing may be executed, and a normalization term that incorporates various known assumptions regarding scenes and the like may be added. Such derivative signal processing is included. There is also a way to avoid the crop error by not making the above assumption and using complex signal processing that requires higher calculation costs, but in the present invention, complex signal processing based on the above assumption is considered.

As illustrated in FIG. 11, when a mask M3 small enough for the light-receiving area of the image capturing element S is employed, all of the light L incident on the mask M3 is received by the image capturing element S. Therefore, the signal processing device 20 can generate the clear decoded image DB from the encoded image DA.

However, to obtain a large amount of light, the size of the mask is preferably large. However, for example, as illustrated in FIG. 11, when a mask M4 having the same size as the light-receiving area of the image capturing element S is employed, the light L incident from the periphery of the mask M4 falls outside the image capturing element S and is not received by the image capturing element S. This causes crop to occur in the image.

In this way, if part of the incident light L cannot be received, some of data required to generate the decoded image DB will be missing, and the assumption of shift invariance will be compromised, and therefore the signal processing device 20 cannot generate the clear decoded image DB from the encoded image DA.

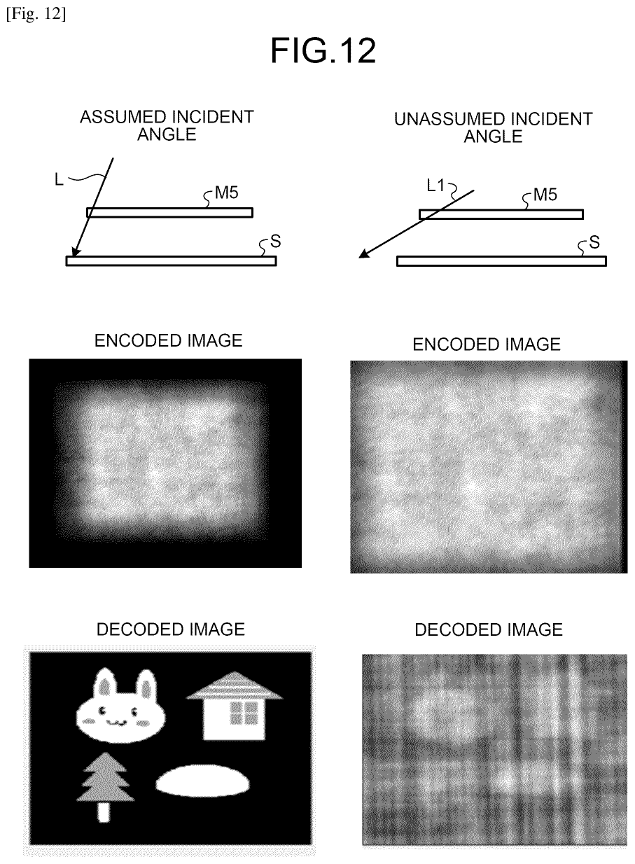

As illustrated in FIG. 12, all of the light L that is incident on a mask M5 at an incident angle within the assumed angle of view is received by the image capturing element S. Therefore, the signal processing device 20 can generate the clear decoded image DB from the encoded image DA.

However, as illustrated in FIG. 12, light L1 that is incident at an incident angle larger than the assumed angle of view falls outside the image capturing element S and is not received by the image capturing element S. This causes crop to occur in the image.

In this way, if part of the incident light L cannot be received, some of data required to generate the decoded image DB will be missing, and therefore the signal processing device 20 cannot generate the clear decoded image DB from the encoded image DA.

Therefore, as illustrated in FIGS. 13 and 14, when the crop rate is 0%, the signal processing device 20 can generate the clear decoded image DB from the encoded image DA, but as the crop rate increases, the image quality of the generated decoded image DB deteriorates rapidly. Therefore, the robust mask according to the second embodiment has a configuration that improves robustness against the crop error.

### 3-2. Robust Mask According to Second Embodiment

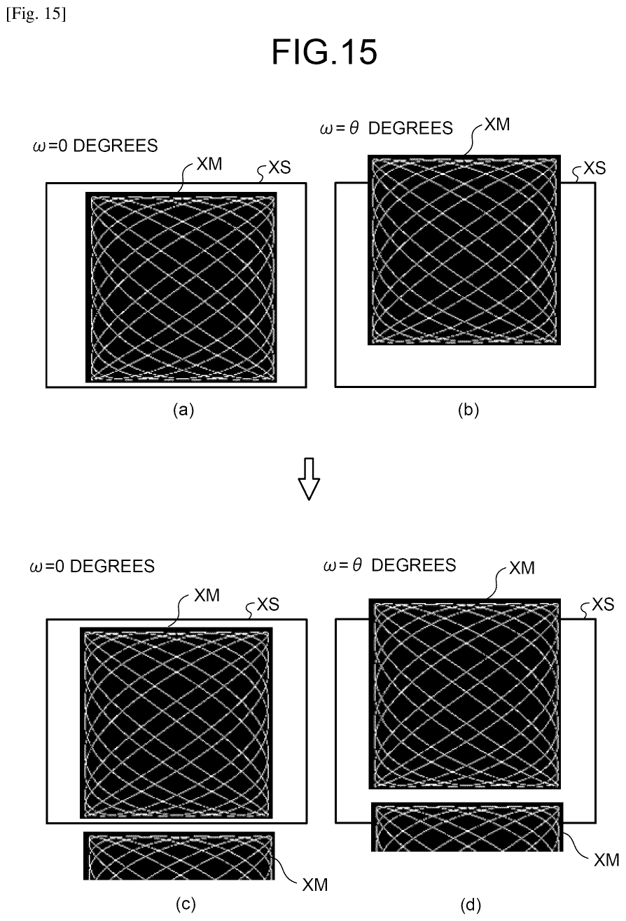

FIG. 15 is an explanatory diagram of the robust mask according to the second embodiment.

Figures (a) and (b) illustrated in the upper figure of FIG. 15 illustrate how information becomes missing due to the crop, and figures (c) and (d) illustrated in the lower figure illustrate how missing information due to the crop is compensated for by the robust mask.

The white rectangular frame XS illustrated in each figure indicates the size of the image capturing element S. The pattern XM illustrated in each figure indicates a two-dimensional intensity pattern (point spread function) formed on the image capturing element S by the mask. In the figures, to make the figures easier to read, only a symmetrical part in one direction and one side of the two-dimensional intensity pattern (point spread function) formed on the image capturing element S by the robust mask is illustrated.

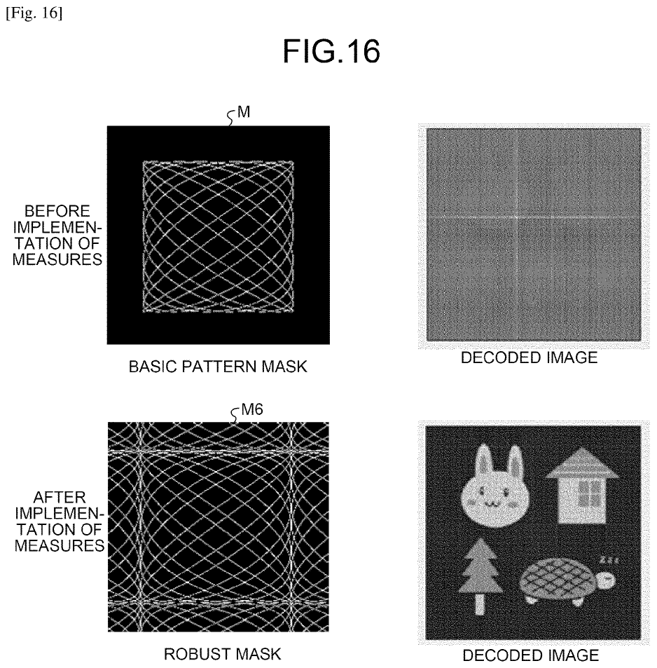

In FIG. 15, a robust mask M6 (for example, see FIG. 16) itself is not illustrated, and a two-dimensional pattern including an optical amplitude modulation region or a phase modulation region having translational symmetry is provided. The center of the mask of the basic pattern and the center of the image capturing element S agree with each other.

Figure (a) illustrates a two-dimensional intensity pattern (point spread function) formed on the image capturing element S when light from one point on the subject passes through the mask that does not have translational symmetry and is incident from a direction perpendicular to the paper (ω)=0 degrees), and all information is received by the image capturing element S.

Figure (b) illustrates a two-dimensional intensity pattern (point spread function) formed on the image capturing element S when light from another point on the subject passes through the mask that does not have translational symmetry and is incident from a direction inclined by θ degrees downward from the perpendicular to the paper (ω=θ degrees), and some information is not received by the image capturing element S.

Figure (c) illustrates a two-dimensional intensity pattern (point spread function) formed on the image capturing element S when light from one point on the subject passes through the mask that has translational symmetry and is incident from a direction perpendicular to the paper (ω=0°), and all information on the basic pattern is received by the image capturing element S.

Figure (d) illustrates a two-dimensional intensity pattern (point spread function) formed on the image capturing element S when light from another point on the subject passes through the mask that has translational symmetry and is incident from a direction inclined by θ degrees downward from the perpendicular to the paper (ω)=θ°). Some basic pattern information is not received by the image capturing element S, but since the two-dimensional intensity pattern (point spread function) has translational symmetry, the missing information is compensated for on the opposite side of the image capturing element S.

In the state illustrated in figure (b), since the assumption of shift invariance is compromised, complex signal processing in deconvolution fails. Since the effect of the failure occurs over the entire region of the decoded image, the entire decoded image deteriorates.

Meanwhile, in the state illustrated in figure (d), it appears that the assumption of shift invariance is compromised, but due to the periodicity of deconvolution by FFT, the assumption of shift invariance is not compromised.

Furthermore, when executing deconvolution-based processing by normal FFT, to avoid the effect of periodicity of convolution by FFT, that is, to avoid the effect of circular convolution, it is necessary to pad a sufficiently large 0 region around the kernel to be convolved (point spread function side) as preprocessing to make it into a linear convolution state.

This process leads to an increase in the memory and calculation amount, but since this method uses the properties of circular convolution inversely, this eliminates the need for these processes, which is advantageous from the viewpoint of memory and calculation amount. As preprocessing for complex signal processing, it is necessary to crop the basic pattern portion of the two-dimensional intensity pattern (point spread function) formed on the image capturing element S, but this tends to further reduce the memory and calculation amount.

### 3-3. Effects by Robust Mask According to Second Embodiment

FIG. 16 is an explanatory diagram of effects of the robust mask according to the second embodiment. For example, as illustrated in FIG. 16, if the mask M3 illustrated in FIG. 11 is employed and the light L incident from the periphery of the mask M3 is not received by the image capturing element S, the signal processing device 20 cannot generate the clear decoded image DB from the encoded image DA.

In contrast, when the robust mask M6 with translational symmetry is employed, the image of light that is incident from a first periphery in the two-dimensional pattern and is not received by the image capturing element S appears in the encoded image DA at a second periphery opposite to the first periphery.

As a result, as illustrated in FIG. 16, by interpolating the image of the missing portion at the first periphery in the encoded image DA with the image appearing at the second periphery on the opposite side of the first periphery, the signal processing device 20 can generate the clear decoded image DB from the encoded image DA.

### 3-4. Pattern Example of Robust Mask According to Second Embodiment

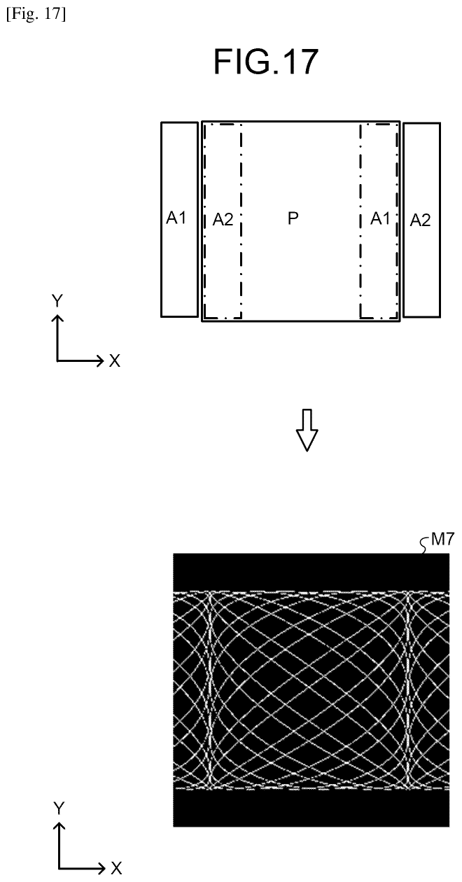

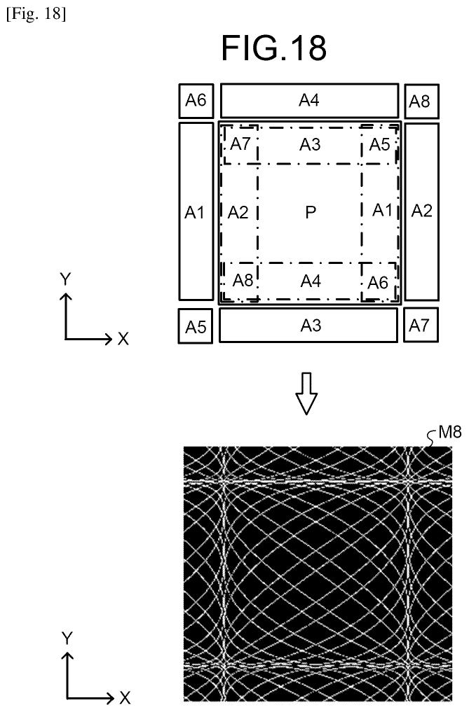

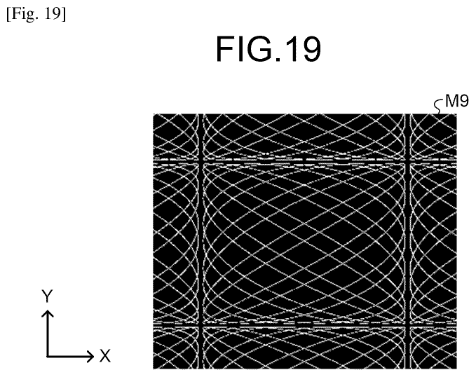

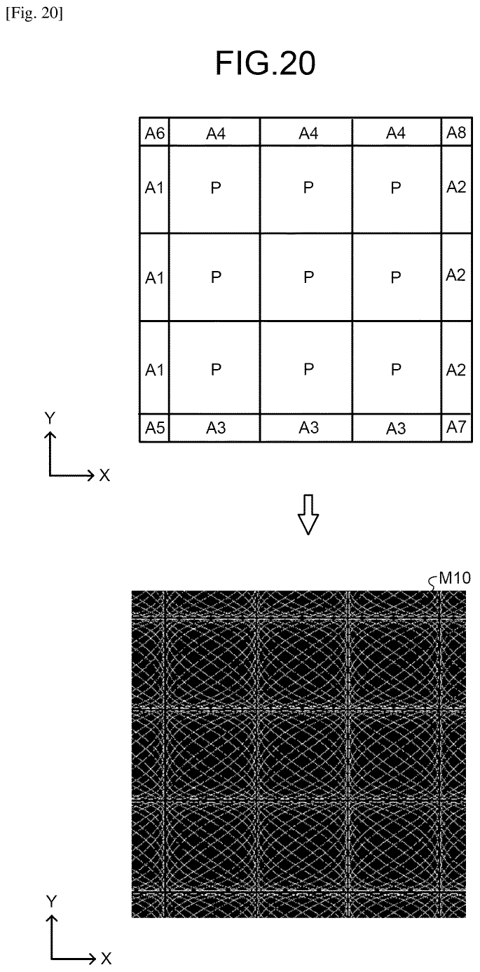

FIGS. 17 to 18 are explanatory diagrams illustrating pattern examples of the robust mask according to the second embodiment. FIG. 17 illustrates a first pattern example, FIG. 18 illustrates a second pattern example, FIG. 19 illustrates a third pattern example, and FIG. 20 illustrates a fourth pattern example.

FIGS. 17 to 18 illustrate the X-Y orthogonal coordinate system for convenience. Here, for convenience, the description will be given in which the X-axis positive direction in the X-Y orthogonal coordinate system is defined as right, the X-axis negative direction is defined as left, the Y-axis positive direction is defined as up, and the Y-axis negative direction is defined as down.

The first pattern of the two-dimensional pattern has one-dimensional translational symmetry. When forming the first pattern, for example, as illustrated in the upper figure of FIG. 17, a partial pattern A1 at the right end of the central basic pattern P is placed outside the left end of the basic pattern P. Furthermore, a partial pattern A2 at the left end of the central basic pattern P is placed outside the right end of the basic pattern P.

As a result, a robust mask M7 illustrated in the lower figure of FIG. 17 can be formed. With the robust mask M7, the signal processing device 20 can interpolate the image of light that is incident on the partial pattern A1 at the right end of the central basic pattern P and leaks from the image capturing element S with the image of incident light on the partial pattern A1 placed outside the left end of the basic pattern P.

Similarly, the signal processing device 20 can interpolate the image of light that is incident on the partial pattern A2 at the left end of the central basic pattern P and leaks from the image capturing element S with the image of incident light on the partial pattern A2 placed outside the right end of the basic pattern P. Therefore, the signal processing device 20 can generate the clear decoded image DB from the encoded image DA.

The second pattern of the two-dimensional pattern has two-dimensional translational symmetry. When forming the second pattern, as illustrated in the upper figure of FIG. 18, the partial pattern A1 at the right end of the central basic pattern P is placed outside the left end of the basic pattern P. The partial pattern A2 at the left end of the central basic pattern P is placed outside the right end of the basic pattern P.

Similarly, a partial pattern A3 at the upper end of the central basic pattern P is placed outside the lower end of the basic pattern P. A partial pattern A24 at the lower end of the central basic pattern P is placed outside the upper end of the basic pattern P.

Furthermore, a partial pattern A5 at the upper right end of the central basic pattern P is placed outside the lower left end of the basic pattern P, and a partial pattern A6 at the lower right end of the central basic pattern P is placed outside the upper left end of the basic pattern P.

Similarly, a partial pattern A7 at the upper left end of the central basic pattern P is placed outside the lower right end of the basic pattern P, and a partial pattern A8 at the lower left end of the central basic pattern P is placed outside the upper right end of the basic pattern P.

As a result, a robust mask M8 illustrated in the lower figure of FIG. 18 can be formed. With the robust mask M8, the signal processing device 20 can similarly interpolate the image of light that is incident from the periphery of the central basic pattern P and leaks from the image capturing element S with the image of incident light on the partial patterns A1 to A8 placed outside the basic pattern P. Therefore, the signal processing device 20 can generate the clear decoded image DB from the encoded image DA.

Note that the aspect ratio of the formation region of the basic pattern P does not have to be 1:1. That is, the shape of the formation region of the basic pattern P does not have to be square. For example, the shape may be rectangular like a robust mask M9 of the third pattern illustrated in FIG. 19. With the robust mask M9 as well, the signal processing device 20 can generate the clear decoded image DB from the encoded image DA.

When forming the fourth pattern, as illustrated in the upper figure of FIG. 20, a plurality of the basic patterns P is arranged in a matrix in the center. In the example illustrated in FIG. 20, nine basic patterns P are arranged in a 3×3 matrix.

Then, in a similar manner to the third pattern, the partial patterns A1 to A8 are arranged at various locations outside the periphery of a nine basic patterns P group. As a result, a robust mask M10 illustrated in the lower figure of FIG. 20 can be formed.

With the robust mask M10, in a similar manner to the robust masks M8 and M9, the image of light that is incident from the periphery of the central basic pattern P group and leaks from the image capturing element S can be interpolated with the image of incident light on the partial patterns A1 to A8 placed outside the basic pattern P group. Therefore, the signal processing device 20 can generate the clear decoded image DB from the encoded image DA.

In the two-dimensional patterns of the first to fourth patterns, preferably, the same pattern repeatedly appears two times or less in the one-dimensional direction. As a result, with the robust masks M7 to M10, when the signal processing device 20 decodes the encoded image DA, the suppression of indeterminate positives makes inverse problems easier to solve.

In the two-dimensional patterns of the first to fourth patterns, the area of the basic pattern P or the basic pattern P group is smaller than the area of the light-receiving region of the image capturing element S. This makes it possible to suppress light incident from the periphery of the basic pattern P or the basic pattern P group from leaking from the light-receiving region of the image capturing element S.

A gap may be provided between the basic pattern P or the basic pattern P group, and the partial patterns Al to A8 arranged outside the basic pattern P or the basic pattern P group. That is, in the two-dimensional pattern, a gap may be provided between the same patterns that repeatedly appear in the one-dimensional direction. This facilitates the process of forming the two-dimensional patterns of the first to fourth patterns. In this case, if the basic pattern including the gap is considered, the above description of the effects applies as is.

Note that regarding the basic pattern, in the first embodiment, the mask M is the basic pattern, whereas in the second embodiment, the repeating unit is the basic pattern. However, the basic pattern can take an arbitrary shape including the internal two-dimensional pattern and its external shape. That is, the internal two-dimensional pattern presents a Lissajous pattern, but this is just one example, and the external shape does not necessarily even have to be rectangular.

### 4. Modification of Image Sensor

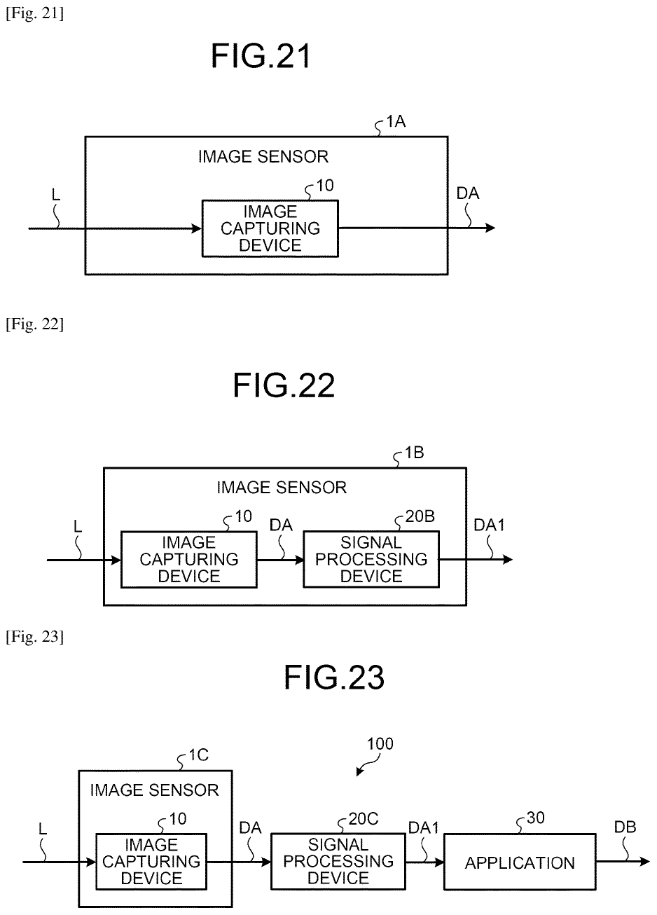

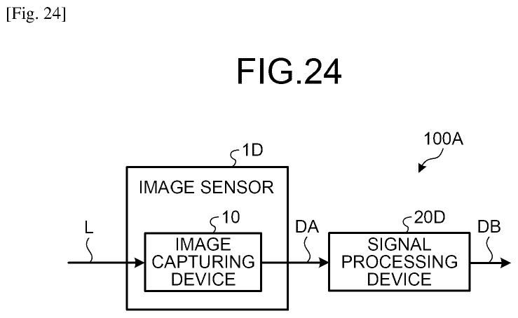

FIGS. 21 to 24 are explanatory diagrams illustrating modifications of the image sensor. FIG. 21 illustrates an image sensor 1A according to a first modification. FIG. 22 illustrates an image sensor 1B according to a second modification. FIG. 23 illustrates an image capturing system 100 including an image sensor 1C according to a third modification. FIG. 24 illustrates an image sensor 1D according to a fourth modification.

As illustrated in FIG. 21, the image sensor 1A according to the first modification includes the image capturing device 10. In this case, since the image sensor 1A does not include the signal processing device 20, the height of the chip can be reduced. Such an image sensor 1A outputs the encoded image DA obtained by capturing an image of a subject. In this case, the encoded image DA output from the image sensor 1A is decoded by a signal processing device provided on a separate chip or cloud.

As illustrated in FIG. 22, the image sensor 1B according to the second modification includes the image capturing device 10 and a signal processing device 20B. The image capturing device 10 outputs the encoded image DA obtained by capturing an image of the subject to the signal processing device 20B.

The signal processing device 20B does not execute decoding processing, but executes signal processing on the encoded image DA to facilitate decoding processing. For example, if the encoded image DA includes the rotation error, the signal processing device 20B executes calibration processing to correct the rotation error. Then, the signal processing device 20B outputs the encoded image DA1 after the calibration processing.

With this configuration, for example, the signal processing device provided on a separate chip that decodes the encoded image DA1 or the cloud can generate the clear decoded image DB by executing common decoding processing for all the image capturing devices 10. Therefore, the cost of the information processing device can be reduced.

As illustrated in FIG. 23, the image capturing system 100 including the image sensor 1C according to the third modification includes the image sensor 1C, a signal processing device 20C, and an application 30. In this case, the signal processing device 20C may be provided on a separate chip or may be provided on the cloud.

The image sensor 1C includes the image capturing device 10. The image capturing device 10 outputs the encoded image DA obtained by capturing an image of the subject to the signal processing device 20C. The signal processing device 20C outputs the encoded image DA1, which has undergone calibration processing on the encoded image DA, to the application 30, in a similar manner to the signal processing device 20B. The application 30 executes decoding processing on the encoded image DA1 to generate and output the decoded image DB.

Note that the signal processing device 20C may be configured to generate the decoded image DB from the encoded image DA and output the decoded image to the application 30. In this case, the application 30 executes some kind of calibration processing on the decoded image DB input from the signal processing device 20C for output. In the image capturing system 100, since the calibration processing and the decoding processing are executed at different locations, security against information leakage can be improved.

As illustrated in FIG. 24, an image capturing system 100A including the image sensor 1D according to the fifth modification includes the image sensor 1D and a signal processing device 20D. The image sensor 1D includes the image capturing device 10. The image capturing device 10 includes any one of the robust masks described in the present disclosure.

The image capturing device 10 outputs the encoded image DA obtained by capturing an image of the subject to the signal processing device 20D. The signal processing device 20D executes decoding processing on the encoded image DA to output the decoded image DB. In the image capturing system 100A, since the generation processing of the encoded image DA and the decoding processing are executed at different locations, security against information leakage can be improved.

Note that the configuration of the mask according to the first embodiment and the configuration of the mask according to the second embodiment can be combined. That is, the mask according to the embodiments may be provided with a two-dimensional pattern including the optical amplitude modulation region or the phase modulation region having the symmetrical component that is symmetrical in the rotation direction about the preset rotation reference point, and the optical amplitude modulation region or the phase modulation region with translational symmetry, and may be configured to guide incident light to the image capturing element. This makes it possible to provide the mask with improved robustness against both the rotation error and the crop error.

Note that the effects described in this specification are merely exemplification and are not restrictive, and other effects may also be possible.

### 5. Additional notes

Note that this technology can also have the following configurations.
(1) A mask, comprising:
   a two-dimensional pattern including an optical amplitude modulation region or a phase modulation region having a symmetrical component that is symmetrical in a rotation direction about a preset rotation reference point, wherein the mask guides, based on the two-dimensional pattern, incident light to an image sensor.
(2) The mask according to (1), wherein
   the rotation reference point is set inside a pattern forming region where the two-dimensional pattern is provided.
(3) The mask according to (2), wherein
   the rotation reference point is set at a position where a distance from a center of gravity of the pattern forming region is equal to or less than half a distance from the center of gravity to a periphery of the pattern forming region.
(4) The mask according to (3), wherein
   the rotation reference point is set at a position of the center of gravity of the pattern forming region.
(5) The mask according to any one of (1) to (4), wherein
   the symmetrical component has a portion in which an arc length of an arc-shaped pattern increases from the rotation reference point toward a periphery of a pattern forming region where the two-dimensional pattern is provided.
(6) The mask according to (5), wherein
   in the symmetrical component, the arc length of the arc-shaped pattern increases from the rotation reference point toward the periphery of the pattern forming region where the two-dimensional pattern is provided.
(7) The mask according to (6), wherein
   in the symmetrical component, the arc length of the arc-shaped pattern increases in proportion to a distance from the rotation reference point.
(8) A mask, comprising:
   a two-dimensional pattern including an optical amplitude modulation region or a phase modulation region having translational symmetry, an area of a repeating portion of the two-dimensional pattern being smaller than an area of a light-receiving region in an image sensor, wherein the mask guides, based on the two-dimensional pattern, incident light to the image sensor.
(9) The mask according to (8), wherein
   the two-dimensional pattern has one-dimensional translational symmetry.
(10) The mask according to (9), wherein
   the two-dimensional pattern has two-dimensional translational symmetry.
(11) The mask according to (8), wherein
   in the two-dimensional pattern,
   an identical pattern repeatedly appears two times or less in a one-dimensional direction.
(12) The mask according to any one of (8) to (11), wherein
   in the two-dimensional pattern,
   a gap is provided between identical patterns that appear repeatedly in a one-dimensional direction.
(13) A mask, comprising:
   a two-dimensional pattern including an optical amplitude modulation region or a phase modulation region having a symmetrical component that is symmetrical in a rotation direction about a preset rotation reference point, and an optical amplitude modulation region or a phase modulation region having translational symmetry, wherein the mask guides, based on the two-dimensional pattern, incident light to an image sensor.
(14) An image capturing device including:
   the mask according to any one of (1), (8), and (13); and
   an image sensor that receives incident light guided by the mask.
(15) An image capturing system including:
   an image capturing device including
      the mask according to any one of (1), (8), and (13), and
      an image capturing element that receives light incident via the mask; and
   a signal processing device that restores an image acquired by the image capturing element.
(16) A data generation method including:
   receiving, by an image sensor, incident light guided by the mask according to any of (1), (8), and (13), and
   generating an encoded image of an image corresponding to the light.
(17) The mask according to (1), wherein
   the optical amplitude modulation region includes members having varying degrees of light transmittance.
(18) The mask according to (1), wherein
   the phase modulation region controls optical phase modulation based on an uneven structure within the mask plane and a refractive index based on a density of members with a plurality of refractive indices at size orders smaller than a wavelength of the incident light.

### REFERENCE SIGNS LIST

1, 1A, 1B, 1C, 1D Image sensor
10 Image capturing device
20, 20B, 20C, 20D Signal processing device
30 Application
100, 100A Image capturing system
M1, M2, M6 to M10 Robust mask
M, M3 to M5 Mask

1. A mask, comprising:
a two-dimensional pattern including an optical amplitude modulation region or a phase modulation region having a symmetrical component that is symmetrical in a rotation direction about a preset rotation reference point, wherein the mask guides, based on the two-dimensional pattern, incident light to an image sensor.

2. The mask according to claim 1, wherein
the rotation reference point is set inside a pattern forming region where the two-dimensional pattern is provided.

3. The mask according to claim 2, wherein
the rotation reference point is set at a position where a distance from a center of gravity of the pattern forming region is equal to or less than half a distance from the center of gravity to a periphery of the pattern forming region.

4. The mask according to claim 3, wherein
the rotation reference point is set at a position of the center of gravity of the pattern forming region.

5. The mask according to claim 1, wherein
the symmetrical component has a portion in which an arc length of an arc-shaped pattern increases from the rotation reference point toward a periphery of a pattern forming region where the two-dimensional pattern is provided.

6. The mask according to claim 5, wherein
in the symmetrical component, the arc length of the arc-shaped pattern increases from the rotation reference point toward the periphery of the pattern forming region where the two-dimensional pattern is provided.

7. The mask according to claim 6, wherein
in the symmetrical component, the arc length of the arc-shaped pattern increases in proportion to a distance from the rotation reference point.

8. A mask, comprising:
a two-dimensional pattern including an optical amplitude modulation region or a phase modulation region having translational symmetry, an area of a repeating portion of the two-dimensional pattern being smaller than an area of a light-receiving region in an image sensor, wherein the mask guides, based on the two-dimensional pattern, incident light to the image sensor.

9. The mask according to claim 8, wherein
the two-dimensional pattern has one-dimensional translational symmetry.

10. The mask according to claim 9, wherein
the two-dimensional pattern has two-dimensional translational symmetry.

11. The mask according to claim 8, wherein
in the two-dimensional pattern,
an identical pattern repeatedly appears two times or less in a one-dimensional direction.

12. The mask according to claim 8, wherein
in the two-dimensional pattern,
a gap is provided between identical patterns that appear repeatedly in a one-dimensional direction.

13. A mask, comprising:
a two-dimensional pattern including an optical amplitude modulation region or a phase modulation region having a symmetrical component that is symmetrical in a rotation direction about a preset rotation reference point, and an optical amplitude modulation region or a phase modulation region having translational symmetry, wherein the mask guides, based on the two-dimensional pattern, incident light to an image sensor.

14. An image capturing device, comprising:
the mask according to claim 1; and
an image sensor that receives incident light guided by the mask.

15. A method, comprising:
receiving, by an image sensor, incident light guided by the mask according to claim 1, and generating an encoded image of an image corresponding to the light.

16. The mask according to claim 1, wherein
the optical amplitude modulation region includes light-blocking members.

17. The mask according to claim 1, wherein
the optical amplitude modulation region includes members having varying degrees of light transmittance.

18. The mask according to claim 1, wherein
the phase modulation region controls optical phase modulation based on an uneven structure within the mask plane and a refractive index based on a density of members with a plurality of refractive indices at size orders smaller than a wavelength of the incident light.

19. An image capturing device, comprising:
the mask according to claim 8; and
an image sensor that receives incident light guided by the mask.

20. An image capturing device, comprising:
the mask according to claim 13; and
an image sensor that receives incident light guided by the mask.
